(19) United States
(12) Patent Application Publication
(10) Pub. No.: US 2009/0270026 A1
(43) Pub. Date: Oct. 29, 2009

(54) METHOD OF CONTROLLING MULTIMEDIA BROADCAST AND MULTICAST SERVICE BEARER IN MOBILE

(76) Inventors: Jae-Wook Shin, Daejon (KR); Kwang-Ryul Jung, Daejon (KR); Kyung-Yul Cheon, Daejon (KR); Ae-Soon Park, Daejon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/518,166

(22) PCT Filed: Dec. 3, 2007
(86) PCT No.: PCT/KR07/06212

§ 371 Date: Jun. 8, 2009

(30) Foreign Application Priority Data
Dec. 8, 2006 (KR) 10-2006-0125160

(51) Int. Cl. H04H 20/71

(52) U.S. Cl. 455/3.01

(57) ABSTRACT

Provided is a method for controlling an MBMS bearer of a mobile terminal. The method includes the steps of: at the RRC, establishing an MBMS bearer for an MBMS service when the RRC is informed of MBMS service session start from outside; at the RRC, informing the RABM of MBMS service session start when the MBMS bearer is established; and receiving MBMS service data from outside through the established MBMS bearer if the RABM transits a session inactive state to a session active state.

### TECHNICAL FIELD

The present invention relates to a method for controlling a multimedia broadcast and multicast service (MBMS) bearer of a mobile terminal; and, more particularly, to a method for controlling an MBMS bearer of a mobile terminal to receive an MBMS service.

This work was supported by the IT R&D program for MIC/IITA [2005-S-404-32, “Research & development on Mobile Terminal Technology based on 3G Evolution”].

### BACKGROUND ART

A 3^{rd} generation partnership project (3GPP) mobile communication network provides a multimedia broadcast and multicast service (MBMS) service in order to effectively transmit multimedia data to a number of users simultaneously.

In order to use wired/wireless resources effectively, the MBMS service defines a uni-directional multicast bearer as an MBMS bearer, not a bidirectional unicast bearer, and transmits multicast data to a number of mobile terminals through the MBMS bearer.

A mobile terminal according to the related art must activate an MBMS service at first in order to receive the MBMS service. Also, the mobile terminal according to the related art must deactivate the activated MBMS service not to receive the activated MBMS service.

An MBMS service is formed of one or more consecutive sessions. Here, the MBMS service data is transmitted during a session. That is, the MBMS service data is not transmitted between sessions.

Due to such reason, the session of a corresponding MBMS service may start or not when the mobile terminal activates the corresponding MBMS service. The start and end of the session is informed to a mobile terminal in a network. That is, if the mobile terminal is informed of the session start from the network, the mobile terminal establishes an MBMS bearer, that is, a unidirectional multicast bearer, to receive MBMS service data. On the contrary, if the mobile terminal is informed of the session end from a network, the mobile terminal releases a corresponding MBMS bearer.

Since a unicast service generally uses a dedicated bearer, a unicast bearer is established when the unicast service is activated. Also, the unicast bearer is released when the unicast service is deactivated. That is, a service activation/deactivation process and a bearer establishment/release process are performed together in order to receive the unicast service.

Therefore, the mobile terminal according to the related art needs a method for controlling a bearer to receive an MBMS service, which is different from a method for controlling a unicast bearer to receive a unicast service.

### DISCLOSURE OF INVENTION

### Technical Problem

An embodiment of the present invention is directed to providing a method for controlling a multimedia broadcast and multicast service (MBMS) bearer at a mobile terminal to receive an MBMS service.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for controlling a multimedia broadcast and multicast service (MBMS) bearer of a mobile terminal including session management (SM), radio resource control (RRC), and radio access bearer management (RABM), including the steps of: at the RRC, establishing an MBMS bearer for an MBMS service when the RRC is informed of MBMS service session start from outside; at the RRC, informing the RABM of MBMS service session start when the MBMS bearer is established; and receiving MBMS service data from outside through the established MBMS bearer if the RABM transits to session active state from session inactive state.

The method may further include: at the SM, generating MBMS context and informing the RABM and the RRC of MBMS service activation when a user activates an MBMS service, before the step of establishing an MBMS bearer for an MBMS service.

The step of establishing an MBMS bearer for an MBMS service may include the steps of: at the SM, removing MBMS context and informing the RABM and the RRC of MBMS service deactivation when a user informs MBMS service deactivation; at the RRC, requesting the RABM to release an established MBMS bearer if the MBMS bearer is previously established; and at the RABM, transiting to service inactive state from service active state if the established MBMS bearer is released.

The method may further include the steps of: at the RRC, informing the RABM of MBMS service session end when the RRC is informed of MBMS service session end after the step of receiving MBMS service data from outside; at the RRC, releasing the established MBMS bearer if the MBMS service session end is informed; and at the RABM, transiting to session inactive state from session active state.

### ADVANTAGEOUS EFFECTS

According to the present invention, a mobile terminal can control an MBMS bearer to receive an MBMS service.

Among MBMS service control processes defined in a protocol of a mobile terminal, control processes for activating an MBMS service or deactivating an MBMS service according to a user request can be independently performed in the present invention. Also, control processes for establishing and releasing an MBMS bearer according to the information of corresponding MBMS service session start or corresponding MBMS service session end from a network can be independently performed in the present invention.

### BRIEF DESCRIPTION OF THE DRAWINGS

FIG. 1 is a diagram illustrating a protocol of a mobile terminal to provide an MBMS service where the present invention is applied to.

FIG. 2 is a diagram showing an MBMS service and a session where the present invention is applied to.

FIG. 3 is a flowchart describing a method for controlling an MBMS bearer to activate an MBMS service at a mobile terminal in accordance with an embodiment of the present invention.

FIG. 4 is a flowchart describing a method for controlling an MBMS bearer to de-activate an MBMS service at a mobile terminal in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

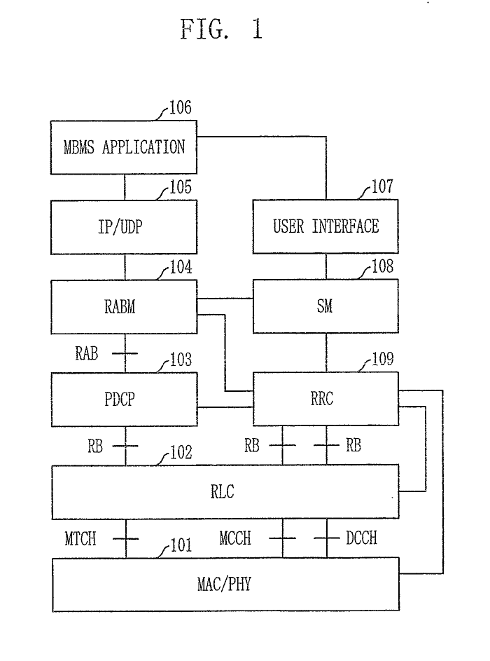

FIG. 1 is a diagram illustrating a protocol of a mobile terminal to provide an MBMS service where the present invention is applied to.

Referring to FIG. 1, the protocol of the mobile terminal is divided into a control plane and a user plane. Signaling is performed to control an MBMS service in the control plane, and an MBMS bearer is provided to receive an MBMS service data in the user plane.

The establishment and release of the MBMS bearer is controlled by a control plane protocol. A MAC/PHY 101 and a radio link control RLC 102 commonly belong to the user plane and the control plane. The session management SM 108 and the radio resource control RRC 109 belong to the control plane, and a packet data convergence protocol PDCP 103 belongs to the user plane.

The MAC/PHY 101 provides an MBMS traffic channel MTCH 111, an MBMS control channel MCCH 112, and a dedicated control channel DCCH 113 to the RLC 102 for receiving an MBMS service.

The RLC 102 provides a radio bearer RB 114 to the PDCP 103 corresponding to the MTCH 111. Also, the RLC 102 provides a DCCH 113 to the RRC 109 corresponding to the RB 116.

The PDCP 103 maps the RB 114 provided from the RLC 102 to a radio access bearer RAB 117 and provide the RB 114 to a radio access bearer management RABM 104. The RABM 104 is a function entity that a mobile terminal locally has. The RAMB 104 matches the IP bearer 105 used by MBMS application 106 with the RAB 117. Here, the RABM 104 manages an activated MBMS service RAB ID and state information.

Meanwhile, if a user requests activation or deactivation of a predetermined MBMS service through an MBMS application 106 of the mobile terminal, the MBMS application 106 informs the SM 108 of the activation request or the deactivation request through a user interface.

The SM 108 creates context for an MBMS service when a user requests the activation of an MBMS service through signaling to a peer SM in a network. Also, the SM 108 deletes context created for an MBMS service when a user requests the deactivation of an MBMS service through signal to a peer SM 108 in a network.

The SM 108 uses radio signaling connection provided from the RRC 109. Here, the radio signaling connection corresponds to the RB 116 provided from the RLC 102.

When the RRC 109 receives a notice of MBMS service session start or a notice of MBMS service session end from a network, the RRC 109 establishes or releases an MTCH 112, an RB 115, and an RAB 118 for receiving MBMS data through signaling with the MAC/PHY 101, the RLC 102, and the PDCP 103.

As described above, an MBMS service is constituted of a number of consecutive sessions. The MBMS service has a structure of repeatedly establishing or releasing a corresponding MBMS bearer when a mobile terminal receives a session start notice or a session end notice from a network.

Accordingly, among MBMS service control processes defined in a protocol of a mobile terminal, control processes for activating an MBMS service or deactivating an MBMS service according to a user request are independently performed in the present embodiment. Also, control processes for establishing and releasing an MBMS bearer according to the information of corresponding MBMS service session start or corresponding MBMS service session end from a network are independently performed in the present embodiment.

That is, the RABM 104 of a mobile terminal performs a control process for activating a service or deactivating a service through signaling to the SM 108 when the MBMS service activation or the MBMS service deactivation is requested from the MBMS application 106.

Also, the RABM 104 of a mobile terminal performs a control process for establishing or releasing an MBMS bearer through signaling with the RRC 109 if a session start notice or a session end notice is received after a corresponding MBMS service is activated. Through such control processes, a mobile terminal effectively controls an MBMS bearer in the present embodiment.

Particularly, a multicast bearer can be effectively controlled for an MBMS service in a 3^{rd} generation mobile terminal by independently managing states of an MBMS service and a session.

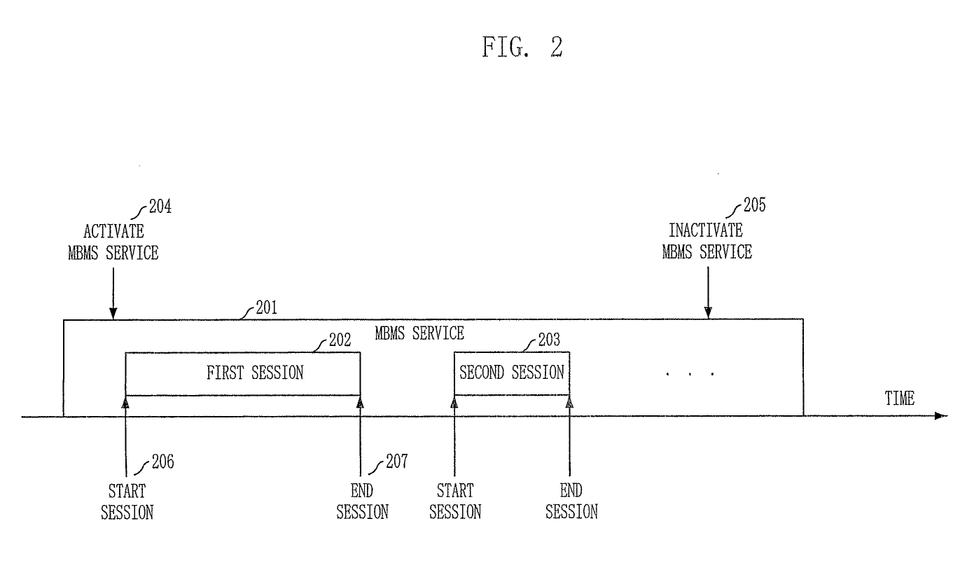

FIG. 2 is a diagram showing an MBMS service and a session where the present invention is applied to.

Referring to FIG. 2, an MBMS service 201 is constituted of one or more consecutive sessions, for example, a first session 202 and a second session 203. Each of the first session 202 and the second session 203 includes one session from a session start 206 to a session end 207. Here, a network multicasts MBMS service data corresponding to one session, that is, from the session start to the session end, is multicasted to a mobile terminal.

The MBMS service 201 is activated by an MBMS service activation request 204 from a user. Here, a mobile terminal establishes a corresponding MBMS bearer when an MBMS service session is already started at an MBMS service activation time 204. On the contrary, the mobile terminal establishes an MBMS bearer at a time of receiving a session start notice 206 from a network if a corresponding MBMS service session is not started at an MBMS service activation time 204. The mobile terminal releases an MBMS bearer for a corresponding MBMS service if a session end message 207 is received from a network.

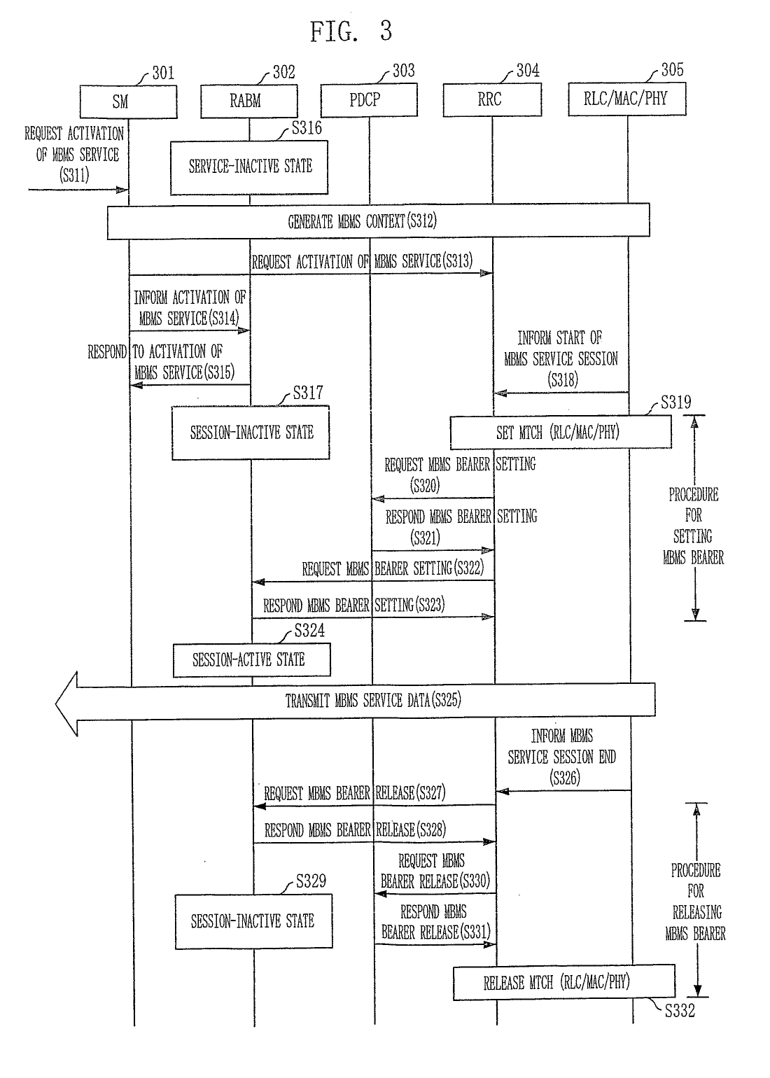

FIG. 3 is a flowchart describing a method for controlling an MBMS bearer to activate an MBMS service at a mobile terminal in accordance with an embodiment of the present invention.

If a predetermined MBMS service of a mobile terminal is activated by a user, a SM 301 generates MBMS context in a mobile terminal and a network and informs the RABM 302 and the RRC 304 of MBMS service activation. Here, the RRC 304 waits for an MBMS service session start message from a network. Also, the RABM 302 transits an MBMS service state from “SERVICE-INACTIVE” to “SERVICE-ACTIVE”

If MBMS service session start is informed from a network, the RRC 304 establishes an MBMS bearer for receiving an MBMS service through signaling with the PDCP 303 and the RLC/MAC/PHY 305. Here, the RABM 302 transits the MBMS service state to “SESSION-ACTIVE”.

When MBMS service session end is informed in the SESSION-ACTIVE state, the RRC 304 releases the previously established MBMS bearer through signaling with the PDCP 303 and the RLC/MAC/PHY 305. Here, the RABM 302 transits an MBMS service state to “SESSION-INACTIVE”.

Hereinafter, a method for controlling an MBMS bearer to activate an MBMS service at a mobile terminal in accordance with an embodiment of the present invention will be described with reference to FIG. 3 in more detail.

Referring to FIG. 3, when a user requests an MBMS service having a predetermined service ID at step S311, the SM 301 generates MBMS context through signaling with a peer SM in a network at step S312.

Then, the SM 301 requests the RRC 304 to active an MBMS service at step S313. Here, the SM 301 transfers a corresponding MBMS service ID and an RAB ID of a corresponding MBMS service to the RRC 304. The SM 301 informs the RAMB 302 of the MBMS service activation at step S314. Here, the SM 301 transfers a flag indicating that an MBMS bearer corresponds to an RAB ID of a corresponding MBMS service and a corresponding RAB. The RABM 302 identifies each of the MBMS services by the RAB ID.

The RABM 302 transfers a response to the SM 301 at step S315 when the RABM 302 is informed of the MBMS service activation from the SM 301. The RABM 302 transits the MBMS service state from “SERVICE-INACTIVE” to “SESSION-ACTIVE” at steps S316 and S317.

When the RRC 304 receives an MBMS NOTIFICATION message from a peer RRC in a network to inform MBMS service session start at step S318, the RRC 304 performs an MBMS bearer establishing process for receiving an MBMS service.

Hereinafter, the MBMS bearer establishing process will be described in detail.

The RRC 304 receives a message from the RLC/MAC/PHY 305 to inform MBMS service session start at step S318. The message may include radio bearer establishing information when the message is a session start message.

Then, the RRC 304 establishes an MTCH of a user plane using the radio bearer establishing information included in the message that informs the session start at step S319.

The RRC 304 requests the PDCP 303 to establish an MBMS bearer for an MBMS service at step S320. The PDCP 303 establishes an MBMS bearer for an MBMS service and transfers a MBMS bearer establishing response to the RRC 304 at step S321.

In addition, the RRC 304 requests the RABM 302 to establish an MBMS bearer at step S322. The RABM 302 transfers the response thereof to the RRC 304 and transits the MBMS service state from “SESSION-INACTIVE” to “SESSION-ACTIVE” at steps S323 and S324.

If the MBMS bearer establishing process from the step S319 to the step S324 is completely performed by the RABM 302, the PDCP 303, and the RLC/MAC/PHY 305, the MBMS service data is transmitted to an IP layer through an MBMS bearer at step S325.

Meanwhile, when the RRC 304 receives an MBMS NOTIFICATIN message from a peer RRC in a network, which indicates session end, at step S326, the RRC 304 performs a process for releasing a previously established MBMS bearer for receiving an MBMS service.

Hereinafter, the process for releasing a previously established MBMS bearer will be described.

The RRC 304 receives a message indicating session end from the RLC/MAC/PHY 305 at step S326. Here, the message includes a corresponding MBMS service ID of a session that will end and a flag indicating session end.

Then, the RRC 304 requests the RABM 302 to release an MBMS bearer at step S327. The RABM 302 transfers the response thereof to the RRC 304 and transits the MBMS service state to “SESSION-INACTIVE” at steps S328 and S329.

The RRC 304 requests the PDCP 303 to release an MBMS bearer allocated to a corresponding MBMS service at step S330. The PDCP 303 responses for the MBMS bearer release request to the RRC 304 at step S331.

The RRC 304 releases an MTCH allocated to an MBMS service through signaling with the RLC/MAC/PHY 305 at step S332.

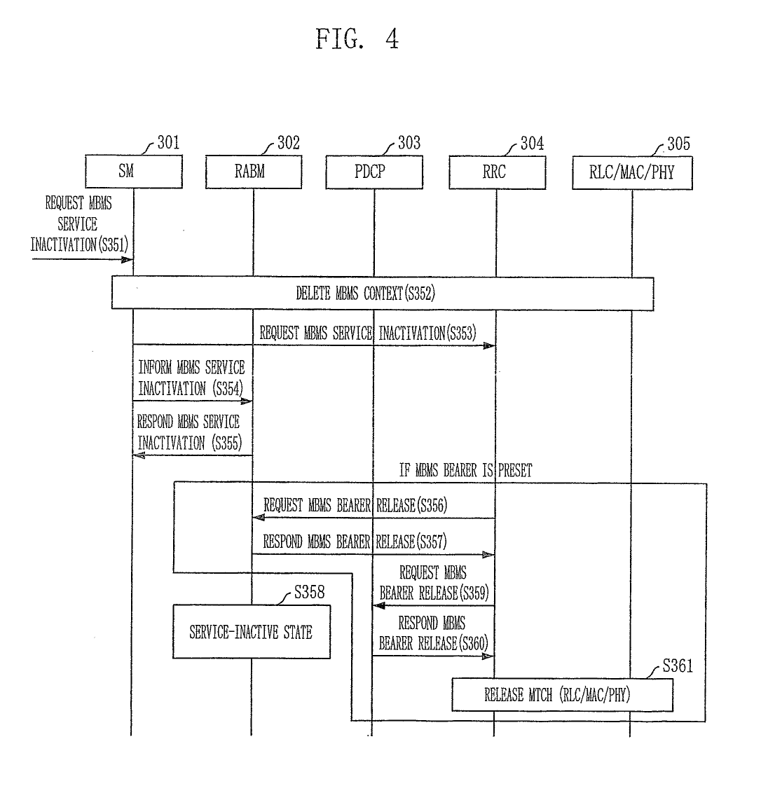

FIG. 4 is a flowchart describing a method for controlling an MBMS bearer to de-activate an MBMS service at a mobile terminal in accordance with an embodiment of the present invention.

When a user deactivates an activated MBMS service, the SM 301 removes MBMS service context from a mobile terminal and a network and informs the RAMB 302 and the RRC 304 of the MBMS service deactivation.

The RRC 304 releases an MBMS bearer through signaling with the PDCP 303 and the RLC/MAC/PHY 305 if an MBMS bearer is previously established for an MBMS service. The RABM 302 transits an MBMS service state to “SERVICE-INACTIVE”.

Hereinafter, a process of deactivating an MBMS service will be described with reference to FIG. 4 in more detail.

Referring to FIG. 4, when a user requests the releasing of an MBMS service having a predetermined service ID at step S301, the SM 301 removes MBMS context through signaling with a peer SM located in a network at step S352.

The SM 301 informs the RRC 304 of MBMS service deactivation at step S353. The SM 301 informs the RAMB 302 that the MBMS service is deactivated at step S354. The RABM 302 responses for the informing of the MBMS service deactivation to the SM 301 at step S355.

When the RRC 304 is informed of the MBMS service deactivation from the SM 301 at step S353, the RRC 304 requests the RABM 302 to release an MBMS bearer at step S356 if an MBMS bearer is previously established for the MBMS service. The RABM 302 responses for the informing of the MBMS service deactivation at step S357.

After completing the MBMS deactivation signaling with the SM 301 and the RRC 304 at steps S354 to S357, the RABM 302 transits an MBMS service state to “SERVICE-INACTIVE” at step S358.

The RRC 304 requests the PDCP 303 to release an MBMS bearer allocated to an MBMS service at step S359. The PDCP 303 responses for the MBMS bearer release at step S360.

Then, the RRC 304 releases an MTCH allocated to the MBMS service through signaling with the RLC/MAC/PHY 305 at step S361.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application No. 2006-0125160, filed in the Korean Intellectual Property Office on Dec. 8, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for controlling a multimedia broadcast and multicast service (MBMS) bearer of a mobile terminal including session management (SM), radio resource control (RRC), and radio access bearer management (RABM), comprising the steps of:
at the RRC, establishing an MBMS bearer for an MBMS service when the RRC is informed of MBMS service session start from outside;
at the RRC, informing the RABM of MBMS service session start when the MBMS bearer is established; and
receiving MBMS service data from outside through the established MBMS bearer if the RABM transits a session inactive state to a session active state.

2. The method of claim 1, further comprising:
at the SM, generating MBMS context and informing the RABM and the RRC of MBMS service activation when a user activates an MBMS service, before the step of establishing an MBMS bearer for an MBMS service.

3. The method of claim 2, wherein the SM transfers an MBMS service ID and an MBMS service RAB ID to the RRC and transfers an MBMS service RAB ID and a flag indicating that MBMS bearer is correspondent to an RAB to the RABM when the SM informs the RABM and the RRC of the MBMS service activation.

4. The method of claim 3, wherein the RABM uses an RAB ID to identify an MBMS service.

5. The method of claim 1, wherein the step of establishing an MBMS bearer for an MBMS service includes the steps of:
at the SM, removing MBMS context and informing the RABM and the RRC of MBMS service deactivation when a user informs MBMS service deactivation;
at the RRC, requesting the RABM to release an established MBMS bearer when the MBMS bearer is previously established; and
at the RABM, transiting a service active state to a service inactive state if the established MBMS bearer is released.

6. The method of claim 1, further comprising the steps of:
at the RRC, informing the RABM of MBMS service session end when the RRC is informed of MBMS service session end after the step of receiving MBMS service data from outside;
at the RRC, releasing an established MBMS bearer if the MBMS service session end is informed; and
at the RABM, transiting a session active state to a session inactive state.

7. The method of claim 1, wherein in the step of establishing an MBMS bearer for an MBMS service, the RRC receives a corresponding MBMS service ID of a session that will start, a flag informing session start, and radio bearer establishing information when the RRC is informed of MBMS service session start.

8. The method of claim 7, wherein the RRC establishes an MBMS traffic channel (MTCH) using the radio bearer establishing information.
